(19) United States
(12) Patent Application Publication
(10) Pub. No.: US 2012/0130804 A1
(43) Pub. Date: May 24, 2012

(54) PREDICTION OF COST AND INCOME ESTIMATES ASSOCIATED WITH A BID RANKING MODEL

(75) Inventors: Jiaqing Guo, Hangzhou (CN); Tao Zhang, Hangzhou (CN); Ning Guo, Hangzhou (CN)

(73) Assignee: ALIBABA GROUP HOLDING LIMITED, George Town (KY)

(21) Appl. No.: 13/301,446

(22) Filed: Nov. 21, 2011

(30) Foreign Application Priority Data
Nov. 22, 2010 (CN) 201010555741.8

(51) Int. Cl. G06Q 30/02

(52) U.S. Cl. 705/14.46

(57) ABSTRACT

Prediction of cost and income estimates associated with a bid ranking model is disclosed, including: receiving a search keyword estimate prediction request, wherein the request comprises a search keyword, a bid price associated with the search keyword, and a prediction period; determining an average click through rate associated with the search keyword associated with the prediction period for a ranking position; determining a traffic value associated with the search keyword associated with the prediction period; determining an average cost per click associated with the search keyword associated with the prediction period for the ranking position; determining a number of impressions associated with the search keyword for the ranking position; and determining a cost estimate and an income estimate associated with the search keyword associated with the prediction period.

### CROSS REFERENCE TO OTHER APPLICATIONS

This application claims priority to People's Republic of China Patent Application No. 201010555741.8 entitled A METHOD AND DEVICE FOR PREDICTING ESTIMATED VALUES OF SEARCH KEYWORDS filed Nov. 22, 2010 which is incorporated herein by reference for all purposes.

### FIELD OF THE INVENTION

The present disclosure relates to the field of online advertising. In particular, it is related to techniques for estimating values associated with search keywords.

### BACKGROUND OF THE INVENTION

In some online advertising campaigns, users such as advertisers purchase search keywords (also known as bid words) so that when a search keyword appears in a search (e.g., at a search engine), an advertisement of an advertiser that has purchased or bid on that search keyword will appear with the web content (e.g., search results) returned based on the search. For each click on an advertisement (e.g., a banner and/or sponsored link), the advertiser pays the bidding price (or another price based at least in part on the bidding price) to the entity (e.g., search engine) that put the advertisement on display. This type of online advertising campaign is often called the pay per click (PPC) model. Typically, such advertisers would prefer to have information on the amount of potential cost to be incurred and the amount of potential income to be received for bidding on a search keyword. Naturally, the more information an advertiser has on the tradeoffs of bidding on a search keyword at a particular price, the better that advertiser is going to allocate its resources in bidding for search keywords.

One type of PPC model involves advertisers bidding for search keywords. In the bid-based model, an advertiser competes with other advertisers in a private auction where each advertiser informs the host of the auction the maximum amount it is willing to pay for a given advertisement spot based on a search keyword. The auction plays out in an automated fashion each time a user action triggers the advertisement spot (e.g., a prompt for a search using the search keyword) to determine which advertiser's advertisement will be displayed at that advertisement spot, based at least in part on the bid prices submitted by the various advertisers for that advertisement spot.

Sometimes, a ranking model is used with respect to a PPC bid based system, where there are several advertisement spots per webpage and the bid prices of the competing advertisers determine which advertisements will be displayed in a more advantageous location among the web content and which will be placed in a less advantageous location. The location at the webpage that a particular advertisement can be displayed is referred to as a ranking position. For example, a ranking position associated with a website can refer to a position among webpage content the sponsored link and/or advertisement (that is relevant to the keywords associated with the website's content) is displayed.

In the bid ranking model, advertisers purchase search keywords at certain prices, and so a certain correlation exists between the costs required (e.g., bid price) and the benefits (e.g., the click traffic to the website for which the advertisement was targeted) actually derived from having bid on the search keywords and also the ranking position at which the advertisements are displayed. Therefore, sometimes, the costs and benefits of bidding for search keywords are generally predicted using ranking positions. However, predictions can also be made using other factors.

In techniques where ranking positions are used to predict costs and benefits for bids on search keywords, the value of the advertiser's bid (price offered) for the search keyword can generally be used to determine the advertiser's ranking position, and the costs and benefits at the determined ranking position can serve as the basis for the prediction results for the advertiser's costs and benefits.

If ranking positions are not used to predict costs and benefits for bids on search keywords, historical data for each advertiser or group of similar advertisers can be used, predicting the advertiser's costs and income using the costs incurred and benefits derived by each advertiser or group of similar advertisers that use the same bid price with respect to the same search keyword.

However, the following problems are present in the search keyword estimate prediction methods described above:

For methods that use ranking position to make predictions, sometimes, after a certain advertiser has offered to bid a certain price to purchase a search keyword, it cannot be guaranteed that the advertiser will remain in one ranking position within the period over which the costs/benefits are predicted. This could result in certain errors in prediction results that are based on the assumption that the advertiser's ranking position will remain unchanged when the advertiser's ranking position changes.

For methods that do not use ranking position to make predictions, the techniques are often based on the following assumptions: it is assumed that in the event that the same advertiser or a similar advertiser offers the same bid for the same search keyword, the variability between historical and future cost and benefits data will be insignificant or there will be no variability. However, this assumption is often not tenable in reality, because search keyword traffic generally differs from day to day, and the number of bidders also varies from day to day. Thus, historical data may not be representative of future data. Moreover, the techniques usually involve a determination of which advertisers are similar to each other, which may introduce errors.

Common situations of variability in the bid ranking model can include predicted cost estimates exceeding the advertiser's anticipated cost limit, predicted benefits estimates being lower than the advertiser's anticipated lower benefits limit, and so on. When cost estimates exceed cost limits and benefits estimates fall below income limits are returned to the advertiser, the advertiser will sometimes once again bid for and initiate predictions for the search keyword, which could result in excessive use of network resources between the advertiser and the search engine. Moreover, the processing of multiple search keyword estimate predictions by the website or search engine in order to satisfy advertiser demands can also increase resource consumption for the relevant equipment within the website or search engine, which may severely impact system performance.

### BRIEF DESCRIPTION OF THE DRAWINGS

Various embodiments of the invention are disclosed in the following detailed description and the accompanying drawings.

FIG. 1 is a diagram showing an embodiment of a system for predicting the cost and income estimates associated with search keywords.

FIG. 2 is a flow diagram showing an embodiment for a process of predicting cost and income estimates associated with search keywords.

FIG. 3 is a flow diagram showing an embodiment of a process for determining the number of impressions associated with a search keyword at a particular ranking position.

FIG. 4 is a diagram showing an embodiment of a system for predicting cost and income estimates associated with search keywords.

FIG. 5 is a diagram showing an example of determination element 403 of system 400

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In various embodiments, the techniques disclosed are used with the pay per click (PPC) (or sometimes called the cost per click) internet advertising model used to direct traffic to websites. Generally, advertisers pay an online publisher (e.g., website or search engine owner) when an advertisement is clicked on by a user. In various embodiments, the techniques disclosed herein can be used with the model of PPC that involves advertisers bidding on search keywords (as opposed to paying flat rates for search keywords) relevant to their target market. In a bid-based PCC model, an advertiser competes with other advertisers in a private auction. The advertiser could inform the host of the auction of the maximum amount (bid price) that he/she is willing to pay for a given ad spot (based on the search keyword). Then, in response to each time a visitor action triggers the ad spot, the auction will play out. For example, if the publisher were a search engine, then the auction can play out as follows: in response to a search query input at the search engine, all bids for the search keyword(s) included in the query that target the searcher's location, date and time of search, etc., are compared and the winning advertiser is determined for each triggered ad spot (e.g., location to display an advertisement among web content). The advertisements associated with the winning advertisements are then displayed at the ad spots among the search results. Generally, the advertisements with higher bid prices show up in earlier (i.e., in more advantageous locations) among the search results and are associated with higher ranking positions. Ultimately, an advertiser pays the search engine when his/her advertisement is clicked on by the searcher. Also, sometimes, an advertiser sets out a certain budget for its advertisement campaign such that once his/her budget is exceeded (i.e., the accrued cost based on the total number of clicks on the advertiser's advertisement exceeds the advertiser's budget), then the advertiser's advertisement will no longer be displayed. As used herein, when an advertisement is no longer displayed (e.g., due to budget reasons), the advertisement and its associated bid price are referred to as being off line.

As used herein, “search keywords” (which are also sometimes referred to as “bid words” or “search terms”), refers to words purchased by users (e.g., advertisers) for determining the placement of an online advertisement. For example, if an advertiser has purchased the search keyword “bookshelf,” then, in some instances, in response to “bookshelf” being input to a search engine associated with the online advertising campaign, an advertisement associated with that advertiser can be displayed with the search results.

As used herein, “publisher” refers to the entity that publishes advertisements of advertisers that are associated with an advertising campaign (e.g., advertisers who bid on search keywords in a PPC campaign). For example, a publisher can be a search engine or a website. As used herein, “ranking position” refers to a position on a webpage (e.g., a website or a list of search results) of a publisher at which an advertisement associated with a search keyword that was bid on by a particular advertiser can be displayed. For example, a ranking position associated with a search engine can refer to a position among the search results that the sponsored link and/or advertisement (that is relevant to the search keywords that prompted the search results) is displayed. For example, a ranking position associated with a website can refer to a position among webpage content that the sponsored link and/or advertisement (that is relevant to the keywords associated with the website's content) is displayed. In various embodiments, the ranking position of a particular advertisement is the average ranking position of that advertisement over some time because each time a user's actions triggers an advertisement spot, a different advertisement may be selected for that spot in that particular instance.

In some embodiments, there is a predetermined number of advertisement spots (where each advertisement spot is associated with the display of one advertisement) per webpage of a publisher. The ranking position of an advertisement associated with a particular search keyword can be associated with each webpage (e.g., each page of search results) or multiple webpages (e.g., multiple pages of search results) of the publisher's. In various embodiments of the techniques disclosed, ranking position is discussed with respect to the ranking of advertisements per each webpage. Generally, the higher ranking position an advertisement has, the more advantageously the publisher will display that advertisement among its web content. For example, a search engine can display an advertisement at a higher ranking position earlier among its search results (on the presumption that it is more advantageous to display an advertisement earlier among search results than later). In various embodiments, the ranking position for an advertisement is determined based on certain rules associated with the bid/price offered by the advertiser for that search keyword and other factors such as the quality of the advertisement. Typically, though not always, the higher an advertiser's bid for the search keyword, the higher position the advertisement of advertiser associated with that keyword will be displayed among the ranked list and thus the greater the likelihood that the advertiser's advertisement will appear (over other advertisements with lower ranking positions).

As used herein, “income” refers to the benefits received by users through the purchase of search keywords. For example, income can include click traffic, feedback quantity, and transaction volume.

As used herein, “costs” refers to expenses that users are required to bear as a result of purchasing the search keyword. For examples, expenses can include the cost the advertiser pays for each click.

As used herein, “prediction period” refers to the future time period over which the publisher is to predict cost estimates and income estimates targeting a user's bid for a particular search keyword. For example, a prediction period can be the coming hour, the coming day, and the coming week. In various embodiments, to estimate income and cost values for a prediction period in the future, historical data from a configurable length of time is used. In some embodiments, historical data over a historical time period is configured to correspond to each length of time of the prediction period.

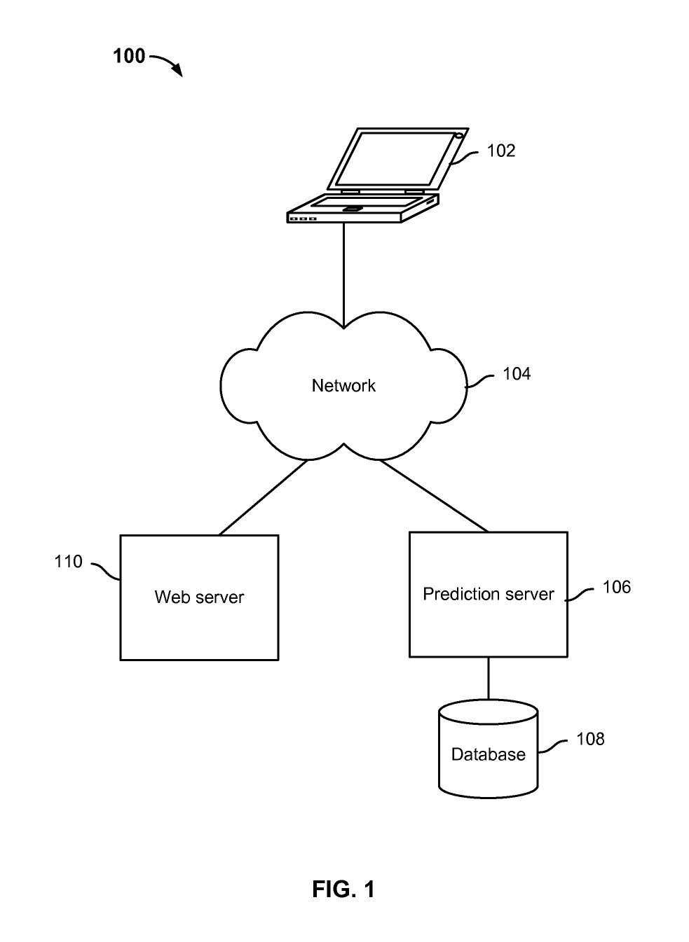

FIG. 1 is a diagram showing an embodiment of a system for predicting the cost and income estimates associated with search keywords. System 100 includes device 102, network 104, prediction server 106, database 108, and web server 110. In some embodiments, network 104 is implemented using high-speed data networks and/or telecommunications networks. In some embodiments, prediction server 106 and the web server 110 are configured to work separately but coordinate with each other and in some embodiments, prediction server 106 and web server 110 are configured to work in combination.

Examples of device 102 include a laptop computer, a desktop computer, a smart phone, a mobile device, a tablet device or any other computing device. Device 102 is configured to communicate with prediction server 106. In various embodiments, an application such as a web-browser is installed at device 102 to enable communication with prediction server 106. For example, a user at device 102 can access a website (e.g., search engine) associated with/hosted by web server 110 by entering a certain uniform resource locator (e.g., URL) at the web browser address bar. For example, the user (e.g., advertiser) can send a search keyword estimate prediction request to prediction server 106 (directly or via web server 110) to receive cost and income estimates associated with a particular search keyword, a bid price, and a prediction period at an user interface presented by device 102. Device 102 can also display the results of the cost and income estimates.

Prediction server 106 is configured to predict cost and income estimates associated with search keyword estimate prediction requests received from clients, such as device 102. In various embodiments, prediction server 106 is associated with and/or is a component of a publisher of online advertisements, such as a search engine or a website. In some embodiments, prediction server 106 is configured to access historical data stored in association with the publisher from database 108. Database 108 can store historical data related to various search keywords that have been purchased in association with the publisher. For example, the historical data can include historical number of clicks of advertisements displayed at each of a plurality of ranking positions at the publisher, historical traffic data, and the historical number of impressions of advertisements.

In some embodiments, prediction server 106 is configured to receive a search keyword estimate prediction request that comprises a search keyword, a bid price, and a prediction period. In some embodiments, prediction server 106 is configured to determine the traffic value associated with the search keyword based on historical data from one or more time periods based on the prediction period. In some embodiments, prediction server 106 is configured to determine an average click through rate for the search keyword, the average cost per click for the search keyword, and the number of impressions associated with the search keyword at each ranking position associated with the publisher. In some embodiments, prediction server 106 is configured to determine a cost estimate and an income estimate associated with the search keyword associated with the prediction period based at least in part on the traffic value, the average click through rate, the number of impressions, and the average cost per click associated with each ranking position.

By obtaining the cost and income estimates of a search keyword for a given bid price at the publisher based on historical data, an advertiser can determine whether the estimated income at that bid price justifies the estimated cost. Different advertisers may have a different cost-benefit analysis process and/or budget and can use the estimates to determine the appropriate bid price it would want to use to obtain desired estimated incomes.

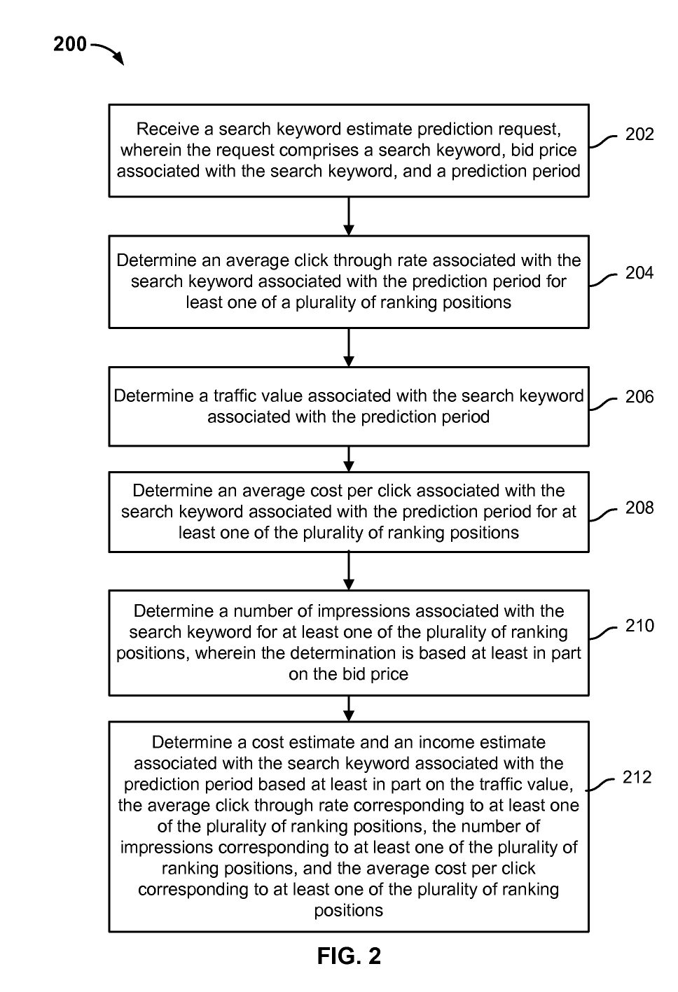

FIG. 2 is a flow diagram showing an embodiment for a process of predicting cost and income estimates associated with search keywords. In some embodiments, process 200 is implemented at system 100.

In various embodiments, process 200 enables a user (e.g., a party that desires to advertise) to determine the estimated cost and income values associated with a publisher's webpage for a given bid price and search keyword. Process 200 is used to obtain estimates with respect to one particular publisher with historical data associated with that publisher (because different publishers can employ different techniques by which to display advertisements, the historical data of one publisher may not accurately reflect the ranking techniques of another publisher).

For example, an advertiser can use process 200 to receive cost estimates and income estimates associated with a certain search engine with which the advertiser would like to advertise. The advertiser can input a request that includes a search keyword that he/she would like to bid on, a bid price for the search keyword, and a prediction period over which the advertiser would like for the prediction to be made. For example, the request can be received and processed at a server associated with the search engine. Then based on the search keyword, the bid price, and the prediction period, a cost estimate and also an income estimate over the prediction period is determined. The cost estimate indicates at least part on how much the advertiser could expect to pay to have his/her advertisement displayed over the course of the predetermined period. Since the bid price is the cost (or is included in the final cost) to the advertiser only per each time that an advertisement of that advertiser is actually clicked on, the cost estimate to an advertiser depends at least in part on the historical number of times that an advertisement that was clicked on (e.g., at various ranking positions) and also was associated with the bid price of the request. The income estimate indicates at least how much the advertiser could expect to benefit (e.g., via traffic to the targeted website, revenue generated) from his/her advertisement being displayed (e.g., at various ranking positions). Then, based on the cost and income estimates, an advertiser can decide for himself/herself if for a given bid price, the cost and income estimates over the prediction period are favorable to his/her goals. The advertiser can even submit a few requests, each with the same search keyword and prediction period but with different bid prices so that the advertiser can see whether there are appreciable cost and income estimate differences between each bid price. For example, if for two different bid prices, the cost and income estimates were not substantially different, then the advertiser might chose to use the lower bid price the next time he/she decides to advertise with the publisher.

At 202, a search keyword estimate prediction request is received, wherein the request comprises a search keyword, a bid price associated with the search keyword, and a prediction period. In various embodiments, the plurality of ranking positions is associated with the publisher for which the income and cost estimates are being made in process 200.

In some embodiments, a user (e.g., advertiser) at a client device sends a search keyword estimate prediction request to a server (e.g., prediction server 106 of system 100). For example, the client can input the parameters (a search keyword, a bid associated with the search keyword, and a prediction period) via a web browser-based user interface. In some embodiments, the request is received by a publisher that supports advertisements among its web content.

In some embodiments, the search keyword of the request may be processed by the publisher based on one or more preconfigured normalization techniques. For example, a publisher can process a keyword to remove the suffix from words so that the keyword of “bookshelves” can be correlated with the keyword of “bookshelf” In some embodiments, the bid price associated with the search keyword is required to conform to one or more criteria set by the publisher. For example, a criterion that a publisher may set for the bid price could be a minimum price such that if the request includes a bid price that falls below the minimum value, the request is bounced back to the sender. In some embodiments, the prediction period is the future time period over which the costs and income estimates will be made for the search keyword of the request. For example, the prediction period may be one hour, one day, one week, or one month. In some embodiments, for each unit of time within the prediction period, the corresponding amount time over which historical data (e.g., related to traffic, historical number of impressions, historical bid prices, historical number of clicks) is used to determine certain values associated with a search keyword is configurable (e.g., by a system administrator).

An example of a search keyword estimate prediction request is as follows: predict the cost estimates and income estimates for the search keyword “bookshelf” at a bid price of $0.50 for the coming day.

At 204, an average click through rate associated with the search keyword associated with the prediction period at least one of a plurality of ranking positions is determined.

In various embodiments, the average click through rate associated with the search keyword associated with the prediction period is determined for each of the plurality of ranking positions at the publisher. The click through rate refers to the number of clicks (e.g., on an advertisement) divided by the number of times the advertisement was displayed (each time an advertisement is displayed is referred to, herein, as an historical impression). In some embodiments, the click through rate is represented by a percentage. In some embodiments, prior to determining the click through rate of a search keyword at a ranking position, historical statistical information (from over a configurable period of time that corresponds to the prediction period) on the search keyword is first determined. For example, historical statistical information associated with various keywords can be maintained by a server associated with a publisher. In various embodiments, historical statistical information that is determined for the search keyword of the request include the number of times advertisements associated with the keyword has been clicked on and also the historical number of impressions of advertisements associated with the search keyword that has been displayed.

For example, for the search keyword “bookshelf” with a prediction period of one day, the historical number of clicks on advertisements (from all advertisers) associated with the search keyword “bookshelf” and the historical number of impressions for advertisements associated with “bookshelf” are determined for each ranking position in the last t days (where t is a configured value). For example, a system administrator may configure t to correspond to the prediction period of one day. Suppose that the historical number of clicks at ranking position i (iε[1, n], where n represents the number of ranking positions associated with the publisher) in the last t days is cᵢ, and the historical number of impressions is pᵢ, then the average click through rate ctrᵢ for the search keyword at ranking position i within the prediction period is

$$\frac{{c}_{i}}{{p}_{i}} .$$

At 206, a traffic value associated with the search keyword associated with the prediction period is determined.

In various embodiments, a traffic value associated with the search keyword refers to the average number of times the search keyword is used with respect to the publisher within a specified amount time. In some embodiments, for each unit of time within the prediction period, the corresponding amount of time over which historical data (e.g., related to traffic) is used to determine the traffic value associated with a search keyword is configurable (e.g., by a system administrator). In some embodiments, the historical data related to traffic of a search keyword at the publisher includes the number of the times that the search keyword was used at any of the ranking positions (i.e., without specificity to one particular ranking position). For example, for a prediction period of the coming day, the average value of daily traffic of the search keyword from the previous seven days can be used as the traffic for the coming day.

In some embodiments, different traffic prediction techniques can be used with respect to different types of historical traffic. For example, for historical traffic data for which variability is relatively low (e.g., as determined based on a predetermined threshold), the average value of the historical traffic data can be used as the traffic value within prediction period pv. For historical traffic data for which variability is relatively great, the historical traffic data can be analyzed using known time series or periodic processing techniques to find the traffic value for prediction period pv. For example, the period over which the traffic value associated with the search keyword is to be determined can be split into multiple time periods and the average value can be determined for each such time period. Then, the traffic value can be taken as the mean value of the averages from the time periods.

At 208, an average cost per click associated with the search keyword associated with the prediction period is determined for at least one of the plurality of ranking positions.

In some embodiments, in determining the average cost per click for the search keyword, historical data is used. In various embodiments, an average cost per click associated with the search keyword associated with the prediction period is determined for each of the plurality of ranking positions.

The average cost per click of the bid price for a search keyword at a ranking position associated with the prediction period is determined to be the average price paid (expenditure) by advertisers per click on an advertisement associated with that search keyword at the ranking position. In other words, the average cost per click of the bid price for a search keyword at the ranking position is the quotient of the total amount of expenditure historically paid per click in association with the search keyword over the total number of clicks for the search keyword at the ranking position within a predetermined quantity of previous time periods corresponding to the prediction period (such as the time periods determined and used for determining the traffic value at 206). For example, if the value of the predetermined quantity of time periods is M, the total amount of expenditure for search keyword “bookshelf” at ranking position i within M previous time periods consistent with the prediction time period is “Cost_{Total}_{_{—}}ᵢ”, and the total number of clicks is “CliCk_{Total}_{_{—}}ᵢ” then the average cost per click for the search keyword at the ranking position, i.e., the average cost per click Cost_{Average}_{_{—}}ᵢ is (cost_{Total}_{_{—}}ᵢ)/CliCk_{Total}_{_{—}}ᵢ.

At 210, a number of impressions associated with the search keyword is determined for at least one of the plurality of ranking positions, wherein the determination is based at least in part on the bid price.

The historical numbers of impressions of advertisements associated with the search keyword corresponding to historical bid prices that are less than or equal to the bid price of the request associated with each ranking position are determined. Each historical bid price corresponds to one historical number of impressions value and the historical number of impressions of a historical bid price at a ranking position is the number of times that an advertisement associated with the search keyword at that bid price has appeared in the publisher's web content at that ranking position. Then, the historical numbers of impressions at each historical bid price less than or equal to the bid price of the request for the ranking position is added together to form the first sum.

The historical numbers of impressions of advertisements associated with the search keyword corresponding to all historical bid prices at each ranking position are determined. Then, the historical numbers of impressions of every historical bid price associated with each ranking position is added together to form the second sum.

The maximum impression ratio for the search keyword associated with the bid price at each ranking position associated with the search keyword of the request is determined to be the quotient of the first sum corresponding to that ranking position divided by the second sum corresponding to that ranking position.

In some embodiments, if historical bid prices that are equal to the bid price of the request are not off line (off line meaning that the historical bid prices are no longer considered for determining the cost and income estimates because the budget of the respective advertiser had been exceeded), then advertisements associated with historical bid prices that are less than the bid price will not be displayed at the ranking position. In other words, advertisements associated with the bid price will be displayed at the ranking position over those associated with lower prices. The reason that multiple prices in the ranking position are targeted for inclusion in the analysis for the historical number of impressions is because higher prices will go off line as the result of exceeding the budget that is set by advertisers. However, if whether advertisements are historically displayed depending on whether their respective budgets are exceeded is not considered, the actual maximum historical number of impressions for a certain price at the ranking position should also include the sum of the number of historical impressions for prices that are less than the price at each ranking position.

Next, the number of impressions for the search keyword at each ranking position associated with the prediction period is determined to be a function of the maximum impression ratio for the search keyword associated with the bid price associated with the ranking position, a maximum impression ratio for the search keyword associated with the bid price associated with the previous ranking position, and the traffic value for the search keyword associated with the prediction period. Note that the number of impressions for the search keyword at the ranking position described above is not the same as the historical number of impressions for the search keyword at the ranking position as mentioned with respect to the average click through rate of 204 because the historical number is determined by tallying up the historical number of times an advertisement associated with the search keyword has appeared at the ranking position, while the number of impressions for the search keyword at the ranking position is determined using the maximum ratios for the search keyword.

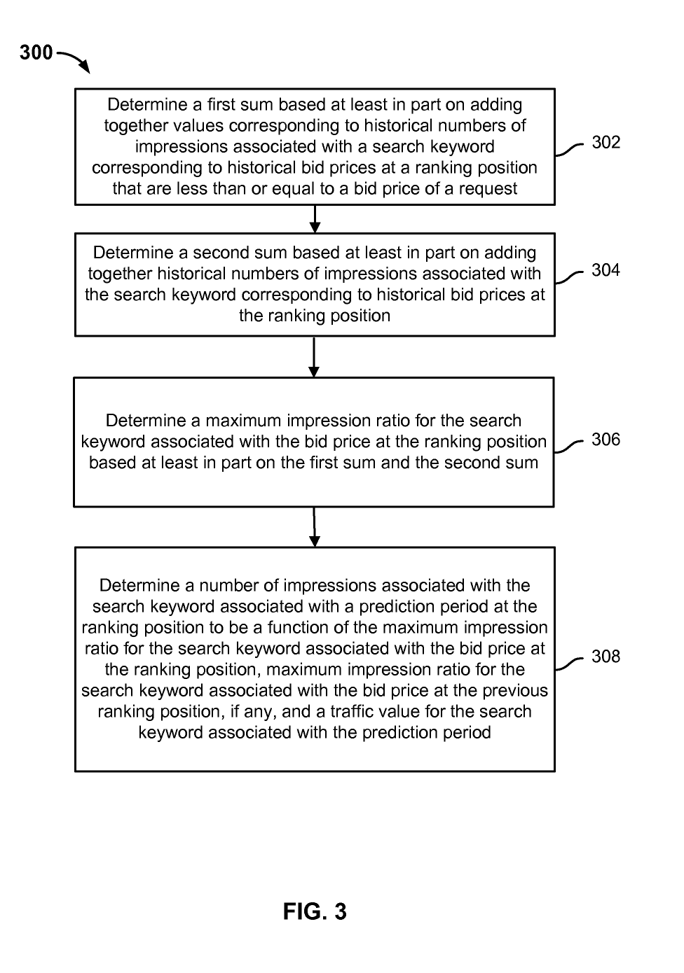

Further examples of 210 are discussed in FIG. 3.

At 212, a cost estimate and an income estimate associated with the search keyword associated with the prediction period are determined based at least in part on the traffic value, the average click through rate corresponding to at least one of the plurality of ranking positions, the number of impressions corresponding to at least one of the plurality of ranking positions, and the average cost per click corresponding to at least one of the plurality of ranking positions.

In some embodiments, the cost estimates and income estimates for the search keyword associated with the prediction period at n ranking positions are determined using the following formulas:

income estimate Σᵢ₌₁ⁿimpᵢ×ctrᵢ×percent (1)

cost estimate Σᵢ₌₁ⁿimpᵢ×ctrᵢ×cost_{Average}_{_{—}}ᵢ (2)

Where Σᵢ₌₁ⁿ expresses a summation operation where iε[1, n], n represents the number of ranking positions; ctrᵢ represents the average click through rate for the search keyword at ranking position i within the prediction period; impᵢ represents the number of impressions for the search keyword at ranking position i within the prediction period, based on the bid price for the search keyword from the request; Cost_{Average}_{_{—}}ᵢ represents the average cost per click for the search keyword at ranking position i within the prediction period; and percent represents a preconfigured (e.g., by a system administrator) conversion rate of the number of clicks to income amount.

In some embodiments, the cost estimate and income estimate determined for the search keyword, bid price, and prediction period associated with the request are displayed at a user interface.

In some embodiments, where there is a specific bid value for a search keyword in the request, if the historical data includes data for the bid value, then the bid values themselves are used in the prediction of cost and income estimates. However, if the historical data does not contain data with the exact value of the bid price, then linear interpolation can be used to determine the prediction result for the bid price using the prediction results for two adjacent prices. For example, for search keyword “bookshelf,” if the bid prices in the historical data include $10 and $20, and the corresponding prediction results (e.g., for income) are $5 and $8, respectively, but the user's bid is $15 (which is not a historical bid price value), then the corresponding prediction results are determined according to the following formula:

$$\frac{( 8 - 5 )}{( 20 - 10 )} * ( 15 - 20 ) + 8 = 6.5$$

Thus in this example, where the bid price for search keyword “bookshelf” is 15, the prediction result (e.g., the income estimate) is 6.5.

In some embodiments, for predictions of search keywords at bid prices in the requests that do not appear in the historical data, the prediction results for the bid price that is closest to the bid price value may also be selected to serve as the prediction results for the bid.

FIG. 3 is a flow diagram showing an embodiment of a process for determining the number of impressions associated with a search keyword at a particular ranking position. In some embodiments, process 300 can be repeated for each ranking position associated with the publisher. In some embodiments, 210 of process 200 can be implemented using process 300.

At 302, a first sum is determined based at least in part on adding together values corresponding to historical numbers of impressions associated with a search keyword corresponding to historical bid prices at the ranking position that are less than or equal to a bid price of a request. In various embodiments, the search keyword and bid price are extracted from a search keyword estimate prediction request. In some embodiments, the historical number of impressions associated with the search keyword at each historical bid price that is less than or equal to the bid price of the request associated with the ranking position is first determined from available historical data associated with the publisher. Then, the historical number of impressions associated with the search keyword of each historical bid price that is less than or equal to the bid price of the request and associated with the ranking position is added together to form the first sum.

At 304, a second sum is determined based at least in part on adding together historical numbers of impressions associated with the search keyword corresponding to historical bid prices at the ranking position. In some embodiments, the historical number of impressions associated with the search keyword at each and every historical bid price associated with the ranking position is first determined from available historical data associated with the publisher. Then, the historical number of impressions of each historical bid price (regardless if it is equal to, greater than, or less than the bid price) is added together to form the second sum.

At 306, a maximum impression ratio for the search keyword associated with the bid price at the ranking position is determined based at least in part on the first sum and the second sum. In some embodiments, the maximum impression ratio is determined as the quotient of the first sum divided by the second sum.

At 308, a number of impressions associated with the search keyword associated with a prediction period at the ranking position is determined to be a function of the maximum impression ratio for the search keyword associated with the bid price at the ranking position, the maximum impression ratio for the search keyword associated with the bid price at the previous ranking position, if any, and a traffic value for the search keyword associated with the prediction period. In some embodiments, the prediction period is included in the search keyword estimate prediction request and indicates the future length of time for which a user that made the request desires for the estimates to be made. In various embodiments, the prediction period determines the length of time from which historical data associated with the publisher to be used to make the predictions.

The maximum impression ratio at the ranking position has been determined at 306. The maximum impression ratio at the previous ranking position (assuming that the ranking position is not the first among the plurality of ranking positions associated with the publisher) can be similarly determined using 302-306 and/or has already been determined and this value can simply be recalled for 308. However, if the ranking position being considered at 300 is the first ranking position, then there is no previous ranking position or associated maximum impression ratio. The traffic value for the search keyword can be determined by a technique similar to that one used for 206.

For example, the number of impressions for the search keyword associated with the prediction period at the ranking position can be determined as the product of multiplying a difference between the maximum impression ratio for the search keyword associated with the bid price at the ranking position and the maximum impression ratio for the search keyword associated with the bid price at the previous ranking position with the traffic value for the search keyword associated with the prediction period.

For example, for the search keyword “bookshelf,” assume that the bid price of the request is p, and the traffic value for the search keyword associated with the prediction period is pv. If the bid price for search keyword “bookshelf” is p, the maximum impression ratio Ratio_{i,p} and the number of impressions imp_{i,p} at ranking position i, the number of historical bid prices for “bookshelf” at ranking position i is j, respectively, can be represented follows, for example:

$$\begin{matrix}{Ratio}_{i , p} = \frac{{\sum }_{j , p \geq {p}_{j}}^{ } {imp}_{i , {p}_{j}}}{{\sum }_{j}^{ } {imp}_{i , {p}_{j}}} & ( 3 ) \\ {imp}_{i , p} = \{ \begin{matrix}pv \times {Ratio}_{i , p} , i = 1 \\ pv \times ( {Ratio}_{i , p} , i - {Ratio}_{i - 1 , p} ) , i > 1\end{matrix} & ( 4 )\end{matrix}$$

Where Ratio_{i,p} represents the maximum impression ratio for search keyword “bookshelf” at ranking position i, where the bid price of the request is p, and where imp_{i,p} represents the number of impressions for the search keyword “bookshelf” at ranking position i. Also, Σ_{j,p≧p} imp_{i,p}_{ⱼ} represents the first sum as determined in 302 and Σⱼ imp_{i,p}_{ⱼ} represents the second sum as determined in 304.

In some embodiments, it is generally true that the maximum impression ratio for a greater ranking position is greater than or equal to the maximum impression ratio for a lower ranking position. This is because advertisements at higher ranking positions tend to be displayed more often. The relationship is shown in the following formula for exemplary purposes, where Ratio_{i1,p} represents the maximum impression ratio at ranking position it and Ratio_{i2,p} represents the maximum impression ratio at ranking position i2, where i1>i2.

Ratio_{i1,p}≧Ratio_{i2,p},i1>i2 (7)

In some embodiments, it is generally true that the maximum impression ratio for a higher bid price is greater than or equal to the maximum impression ratio for a lower bid price at the same ranking position. This is because advertisements associated with higher bid prices tend to be at higher ranking positions. The relationship is shown in the following formula for exemplary purposes, where Ratio_{i,p1} represents the maximum impression ratio for bid price p1 and Ratio_{i,p2} represents the maximum impression ratio for bid price p2, where p1>p2.

Ratio_{i,p1}≧Ratio_{i,p2},p1>p2 (8)

For example, suppose that three historical bid prices for search keyword “bookshelf” are $0.50, $1.20, and $1.50, and the respective historical number of impressions for each historical bid price at ranking position i are 200, 250, and 50, respectively and the respective historical number of impressions of the historical bid prices at ranking position i−1 are 100, 150, and 250. The traffic value for the search keyword associated with the prediction period is 600. If the bid price included in the request for the search keyword “bookshelf” were $1.20, then the maximum impression ratio Ratio_{i1.20} at ranking position i would be: (200+250)/(50+200+250)=90%, the maximum impression ratio Ratio_{i-1.20} at ranking position i−1 would be: (150+100)/(250+150+100)=50%, and the number of impressions imp_{i,20} at ranking position i would be: 600*(90%-50%)=240.

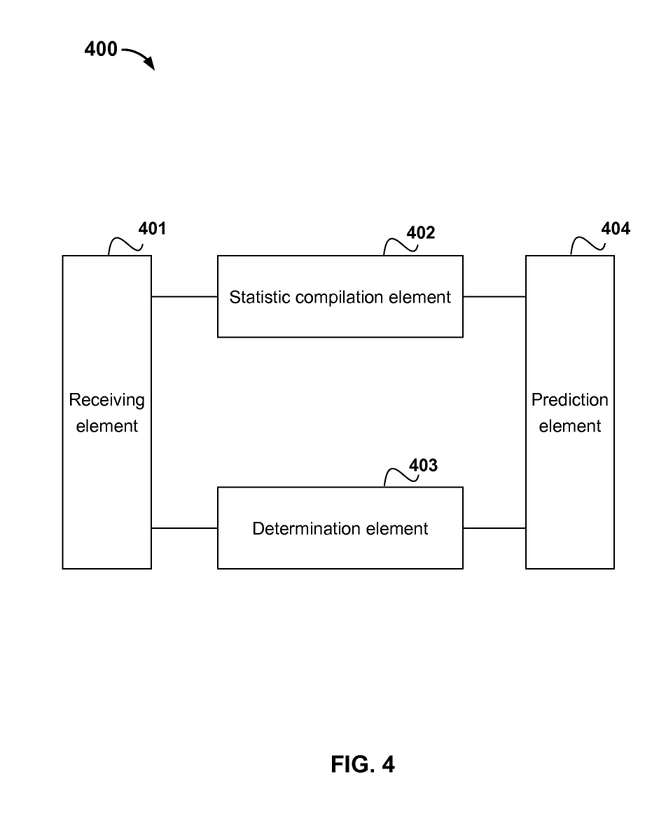

FIG. 4 is a diagram showing an embodiment of a system for predicting cost and income estimates associated with search keywords.

The elements and subelements can be implemented as software components executing on one or more processors, as hardware such as programmable logic devices and/or Application Specific Integrated Circuits designed to perform certain functions or a combination thereof. In some embodiments, the elements and subelements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The elements and subelements may be implemented on a single device or distributed across multiple devices.

Receiving element 401 is configured to receive the search keyword estimate prediction request (e.g., sent by a client device) and the prediction request comprises the search keyword, the bid price for the search keyword, and the prediction period.

Statistic compilation element 402 is configured to determine the number of impressions and the average click-through rate for the search keyword associated with the prediction period at each ranking position.

Determination element 403 is configured to determine the average cost per click for the search keyword associated with the prediction period, based on the bid price for the search keyword.

Prediction element 404 is configured to predict the cost estimates and income estimates for the search keyword associated with the described prediction period, based on the average click-through rate, number of impressions and average cost per click for the search keyword at each ranking position associated with the prediction period, and return them to the client device.

In some embodiments, statistic compilation element 402 further comprises:

A first statistic compilation subelement that is configured to determine the historical number of clicks and historical number of impressions for the search keyword at each ranking position associated with a predetermined quantity of previous time periods, where the predetermined quantity of previous time periods is determined based on the prediction period.

A first determination subelement that is configured to, for each ranking position, determine the quotient of the historical number of clicks divided by historical number of impressions determined for the current ranking position to be the average click-through rate for the search keyword at the current ranking position associated with the prediction period.

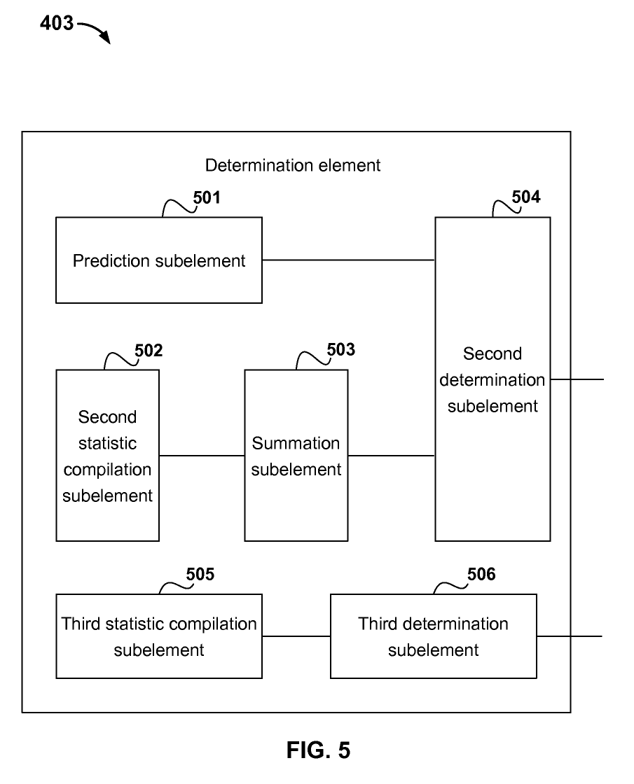

FIG. 5 is a diagram showing an example of determination element 403 of system 400.

Prediction subelement 501 is configured to determine the traffic value for the search keyword associated with the prediction period based on the historical traffic data for the search keyword of the request.

Second statistic compilation subelement 502 is configured to determine the historical number of impressions for the search keyword at each ranking position, separating the data for the historical number of impressions for the search keyword at each ranking position associated with each historical bid price.

Summation subelement 503 is configured to, for each ranking position, add together the historical number of impressions at the ranking position for each historical bid price that is less than or equal to the bid price of the request to obtain a first sum. Summation subelement 502 is also configured to, for each ranking position, add together the historical number of impressions for all bid prices at the ranking position to obtain a second sum. Summation subelement 502 is also configured to, for each ranking position, determine the maximum impression ratio at the ranking position as the quotient of the first sum corresponding to that ranking position divided by the second sum corresponding to that ranking position.

Second determination subelement 504 is configured to determine the number of impressions for the search keyword at each ranking position associated with the prediction period to be the product of the difference between the maximum impression ratio of the bid price associated with the search keyword at the current ranking position and the maximum impression ratio of the bid price associated with the search keyword at the previous ranking position and the traffic value for the search keyword associated with the prediction period.

Third statistic compilation subelement 505 is configured to determine the total cost and the total number of clicks for the search keyword at each ranking position associated a predetermined quantity of previous time periods, wherein the time periods correspond to the length of time indicated in the prediction period.

Third determination subelement 506 is configured to, for each ranking position, to determine the quotient of the total cost and the total number of clicks on advertisements associated with the ranking position to be the average cost per click for the search keyword at the ranking position associated with the prediction period.

In some embodiments, prediction subelement 501 is configured to determine the traffic value for the search keyword associated the prediction period to be the mean of traffic data for the search keyword within a historical time period of predetermined quantity that corresponds to the length of time indicated in the prediction period.

A person skilled in the art should understand that the embodiments of the present application can be provided as methods, systems or computer software products. Therefore, the present disclosure can take the form of embodiments consisting entirely of hardware, embodiments consisting entirely of software, and embodiments which combine software and hardware. Moreover, the present disclosure can take the form of computer programs implemented on one or more computer-operable storage media (including but not limited to magnetic disk storage devices, CD-ROMs, and optical storage devices) containing computer program codes.

The present application is described with reference to flow charts and/or block diagrams based on methods, equipment (systems) and computer program products. It should be understood that each process and/or block in the flow charts and/or block diagrams, and combinations of processes and/or blocks in the flow charts and/or block diagrams, can be achieved through computer program commands. One can provide these computer commands to a general-purpose computer, a specialized computer, an embedded processor or the processor of other programmable data equipment so as to give rise to a machine, with the result that the commands executed through the computer or processor of other programmable data equipment give rise to a device that is used to realize the functions designated by one or more processes in a flow chart and/or one or more blocks in a block diagram.

These computer program commands can also be stored on specially-operating computer-readable storage devices that can guide computers or other programmable data equipment, with the result that the commands stored on these computer-readable devices give rise to products that include command devices. These command devices realize the functions designated in one or more processes in a flow chart and/or one or more blocks in a block diagram.

These computer program commands can also be loaded onto a computer or other programmable data equipment, with the result that a series of operating steps are executed on a computer or other programmable equipment so as to give rise to computer processing. In this way, the commands executed on a computer or other programmable equipment provide steps for realizing the functions designated by one or more processes in a flow chart and/or one or more blocks in a block diagram.

Although preferred embodiments of the present application have already been described, a person skilled in the art can make other modifications or revisions to these embodiments once he grasps the basic creative concept. Therefore, the attached claims are to be interpreted as including the preferred embodiments as well as all modifications and revisions falling within the scope of the present application.

A person skilled in the art can modify and vary the present application without departing from the spirit and scope of the present invention. Thus, if these modifications to and variations of the present application lie within the scope of its claims and equivalent technologies, then the present application intends to cover these modifications and variations as well.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a search keyword estimate prediction request, wherein the request comprises a search keyword, a bid price associated with the search keyword, and a prediction period;
determining an average click through rate associated with the search keyword associated with the prediction period for at least one of a plurality of ranking positions;
determining a traffic value associated with the search keyword associated with the prediction period;
determining an average cost per click associated with the search keyword associated with the prediction period for at least one of the plurality of ranking positions;
determining a number of impressions associated with the search keyword for at least one of the plurality of ranking positions, wherein the determination is based at least in part on the bid price; and
determining a cost estimate and an income estimate associated with the search keyword is associated with the prediction period based at least in part on the traffic value, the average click through rate corresponding to at least one of the plurality of ranking positions, the number of impressions corresponding to at least one of the plurality of ranking positions, and the average cost per click corresponding to at least one of the plurality of ranking positions.

2. The method of claim 1, wherein determining the number of impressions associated with the search keyword for at least one of the plurality of ranking positions includes:
determining a first sum based at least in part on adding together values corresponding to historical numbers of impressions associated with the search keyword corresponding to historical bid prices at the ranking position that are less than or equal to the bid price;
determining a second sum based at least in part on adding together historical numbers of impressions associated with the search keyword corresponding to historical bid prices at the ranking position;
determining a maximum impression ratio for the search keyword associated with the bid price at the ranking position based at least in part on the first and the second sum; and
determining a number of impressions associated with the search keyword associated with the prediction period at the ranking position to be a function of the maximum impression ratio for the search keyword associated with the bid price at the ranking position, maximum impression ratio for the search keyword associated with the bid price at the previous ranking position, if any, and the traffic value for the search keyword associated with the prediction period.

3. The method of claim 1, wherein the plurality of ranking positions is associated with a search engine.

4. The method of claim 1, wherein the prediction period determines a corresponding configurable time period over which historical data associated with the search keyword is to be used.

5. The method of claim 4, wherein the historical data includes historical numbers of clicks of displayed advertisements, historical traffic data, and historical numbers of impressions of advertisements.

6. The method of claim 1, wherein the average click through rate is determined based on a historical number of clicks on advertisements associated with the search keyword at the ranking is position divided by a historical number of impressions associated with the search keyword at the ranking position.

7. The method of claim 1, wherein the traffic value is determined based on a mean value of historical traffic data associated with the search keyword over a historical period of time corresponding to the prediction period.

8. The method of claim 1, wherein the average cost per click is determined based on a total expenditure for the search keyword at the ranking position divided by a total number of clicks for the search keyword at the ranking position.

9. The method of claim 1, wherein the income estimate comprises a product of the number of impressions, the average click through rate, and a preconfigured conversion rate.

10. The method of claim 1, wherein the cost estimate comprises a product of the number of impressions, the click through rate, and the average cost per click.

11. A system, comprising:
a processor configured to:
receive a search keyword estimate prediction request, wherein the request comprises a search keyword, bid price associated with the search keyword, and a prediction period;
determine an average click through rate associated with the search keyword associated with the prediction period for at least one of a plurality of ranking positions;
determine a traffic value associated with the search keyword associated with the prediction period;
determine an average cost per click associated with the search keyword associated with the prediction period for at least one of the plurality of ranking positions;
determine a number of impressions associated with the search keyword for at least one of the plurality of ranking positions, wherein the determination is based at least in part on the bid price; and
determine a cost estimate and an income estimate associated with the search keyword associated with the prediction period based at least in part on the traffic value, is the average click through rate corresponding to at least one of the plurality of ranking positions, the number of impressions corresponding to at least one of the plurality of ranking positions, and the average cost per click corresponding to at least one of the plurality of ranking positions; and
a memory coupled with the processor and configured to provide the processor with instructions.

12. The system of claim 11, wherein to determine the number of impressions associated with the search keyword for at least one of the plurality of ranking positions includes:
determining a first sum based at least in part on adding together values corresponding to historical numbers of impressions associated with the search keyword corresponding to historical bid prices at the ranking position that are less than or equal to the bid price;
determining a second sum based at least in part on adding together historical numbers of impressions associated with the search keyword corresponding to historical bid prices at the ranking position;
determining a maximum impression ratio for the search keyword associated with the bid price at the ranking position based at least in part on the first and the second sum; and
determining a number of impressions associated with the search keyword associated with the prediction period at the ranking position to be a function of the maximum impression ratio for the search keyword associated with the bid price at the ranking position, maximum impression ratio for the search keyword associated with the bid price at the previous ranking position, if any, and the traffic value for the search keyword associated with the prediction period.

13. The system of claim 11, wherein the average click through rate is determined based on a historical number of clicks on advertisements associated with the search keyword at the ranking position divided by a historical number of impressions associated with the search keyword at the ranking position.

14. The system of claim 11, wherein the traffic value is determined based on a mean value of historical traffic data associated with the search keyword over historical period of time corresponding to the prediction period.

15. The system of claim 11, wherein the average cost per click is determined based on a total is expenditure for the search keyword at the ranking position divided by a total number of clicks for the search keyword at the ranking position.

16. The system of claim 11, wherein the income estimate comprises a product of the number of impressions, the average click through rate, and a preconfigured conversion rate.

17. The system of claim 11, wherein the cost estimate comprises a product of the number of impressions, the click through rate, and the average cost per click.

18. A computer program product, the computer program product being embodied in a non-transitory computer readable storage medium and comprising computer instructions for:
receiving a search keyword estimate prediction request, wherein the request comprises a search keyword, a bid price associated with the search keyword, and a prediction period;
determining an average click through rate associated with the search keyword associated with the prediction period for at least one of a plurality of ranking positions;
determining a traffic value associated with the search keyword associated with the prediction period;
determining an average cost per click associated with the search keyword associated with the prediction period for at least one of the plurality of ranking positions;
determining a number of impressions associated with the search keyword for at least one of the plurality of ranking positions, wherein the determination is based at least in part on the bid price; and
determining a cost estimate and an income estimate associated with the search keyword associated with the prediction period based at least in part on the traffic value, the average click through rate corresponding to at least one of the plurality of ranking positions, the number of impressions corresponding to at least one of the plurality of ranking positions, and the average cost per click corresponding to at least one of the plurality of ranking positions.

19. The computer program product of claim 18, wherein determining the number of impressions associated with the search keyword for at least one of the plurality of ranking positions includes:
determining a first sum based at least in part on adding together values corresponding to historical numbers of impressions associated with the search keyword corresponding to historical bid prices at the ranking position that are less than or equal to the bid price;
determining a second sum based at least in part on adding together historical numbers of impressions associated with the search keyword corresponding to historical bid prices at the ranking position;
determining a maximum impression ratio for the search keyword associated with the bid price at the ranking position based at least in part on the first and the second sum; and
determining a number of impressions associated with the search keyword associated with the prediction period at the ranking position to be a function of the maximum impression ratio for the search keyword associated with the bid price at the ranking position, maximum impression ratio for the search keyword associated with the bid price at the previous ranking position, if any, and the traffic value for the search keyword associated with the prediction period.
